(19) United States
(12) Patent Application Publication
(10) Pub. No.: US 2026/0266983 A1
(43) Pub. Date: Sep. 10, 2026

(54) OBJECT DETECTION DEVICE AND OBJECT DETECTION METHOD

(71) Applicants: DENSO CORPORATION, Kariya-city (JP); J-QuAD DYNAMICS Inc., Tokyo (JP)

(72) Inventors: Ryuta YAMAZAKI, Tokyo (JP); Masaya TAKATSUJI, Tokyo (JP)

(21) Appl. No.: 19/555,595

(22) Filed: Mar. 3, 2026

(30) Foreign Application Priority Data
Mar. 7, 2025 (JP) 2025-036727

(51) Int. Cl. G01S 13/89

(52) U.S. Cl. CPC G01S 13/89

(57) ABSTRACT

In an object detection device according to the present disclosure, an acquisition unit is configured to acquire a grid map generated by dividing an area around a host vehicle into a plurality of grid squares, and detected coordinate positions that represent coordinate positions, on the grid map, of objects detected by a probe wave sensor. An output unit is configured to add, for each of the detected coordinate positions, a predefined number of votes to a vote count of a main grid square corresponding to the detected coordinate position and to vote counts of surrounding grid squares that surround the main grid square and are located on a first line derived from the detected coordinate positions, and output coordinate positions of grid squares whose vote counts are greater than or equal to a vote threshold.

### CROSS-REFERENCE TO RELATED APPLICATION

This application is based on and claims the benefit of priority from earlier Japanese Patent Application No. 2025-036727 filed Mar. 7, 2025, the description of which is incorporated herein by reference.

### BACKGROUND

### Technical Field

The present disclosure relates to an object detection device and an object detection method.

### Related Art

Conventionally, an object detection device has been known that detects objects around a host vehicle by using a grid map acquired by dividing an area around the host vehicle into a plurality of grid squares. The object detection device includes an object recognition unit, a grid generation unit, and an object identification unit. The object recognition unit receives sensing information from a ranging sensor, and generates a grid map indicating detected coordinate positions corresponding to positions at which detected objects included in the sensing information from the ranging sensor. The ranging sensor measures a position of an object by outputting a probe wave and acquiring a reflected wave of the probe wave from the object. The grid generation unit generates a grid map indicating positions of objects around the host vehicle by adding, for each detected coordinate position, a predefined number of votes to a vote count of a main grid square corresponding to the detected coordinate position and to surrounding grid squares located around the main grid square. The object identification unit identifies, as grid squares in which an object is present, grid squares in the grid map generated by the grid generation unit whose number of votes exceeds a predefined threshold. The object identification unit regards a detected coordinate position corresponding to the identified grid squares as a detected coordinate position of an actual object.

### BRIEF DESCRIPTION OF THE DRAWINGS

In the accompanying drawings:

FIG. 1A is a block diagram of a host vehicle to which an object detection device according to one embodiment is applied;

FIG. 1B is a functional block diagram of the object detection device illustrated in FIG. 1A;

FIG. 2 is a flowchart of a routine performed by the object detection device;

FIG. 3 is an illustration of a current position calculated by the object detection device;

FIG. 4 is an illustration of a grid map generated by the object detection device;

FIG. 5 is an illustration of detected coordinate positions calculated by the object detection device;

FIG. 6 is an illustration of processing in a comparative example;

FIG. 7 is an illustration of first additive voting by the object detection device;

FIG. 8 is an illustration of first subtractive voting by the object detection device;

FIG. 9 is an illustration of second additive voting by the object detection device; and

FIG. 10 is an illustration of second subtractive voting by the object detection device.

### DESCRIPTION OF SPECIFIC EMBODIMENTS

In the object detection device disclosed in JP 2021-135192 A, when a thin wall-like object extending in a travel direction of a host vehicle is detected by a ranging sensor, votes are added in a thickness direction of the wall-like object. The thickness direction is perpendicular to both the travel direction and a vertical direction of the host vehicle. Consequently, a number of votes are added to vote counts of grid squares at positions where no wall actually exists, causing such grid squares to be erroneously identified as grid squares in which an object is present. Therefore, in the object detection device disclosed in JP 2021-135192 A, the shape of the object causes a reduction in object detection accuracy.

In view of the foregoing, it is desired to have an object detection device and an object detection method capable of suppressing a decrease in object detection accuracy.

A first aspect of the present disclosure provides an object detection device including: an acquisition unit configured to acquire a grid map generated by dividing an area around a host vehicle into a plurality of grid squares, and detected coordinate positions that represent coordinate positions, on the grid map, of objects detected by a probe wave sensor; and an output unit configured to add, for each of the detected coordinate positions, a predefined number of votes to a vote count of the main grid square corresponding to the detected coordinate position and to vote counts of surrounding grid squares that surround the main grid square and are located on a first line derived from the detected coordinate positions, and outputs coordinate positions of grid squares whose vote counts are greater than or equal to a vote threshold.

A second aspect of the present disclosure provides an object detection method including: acquiring a grid map generated by dividing an area around a host vehicle into a plurality of grid squares, and detected coordinate positions that represent coordinate positions, on the grid map, of objects detected by a probe wave sensor ; and adding, for each of the detected coordinate positions, a predefined number of votes to a vote count of the main grid square corresponding to the detected coordinate position and to vote counts of surrounding grid squares, surrounding the main grid square, that are located on a first line derived from the detected coordinate positions, and outputs coordinate positions of grid squares whose vote counts are greater than or equal to a vote threshold.

A second aspect of the present disclosure provides a computer program product including instructions which, when executed by a computer, cause the computer to perform an object detection method including: acquiring a grid map generated by dividing an area around a host vehicle into a plurality of grid squares, and detected coordinate positions that represent coordinate positions, on the grid map, of objects detected by a probe wave sensor; and adding, for each of the detected coordinate positions, a predefined number of votes to a vote count of the main grid square corresponding to the detected coordinate position and to vote counts of surrounding grid squares, surrounding the main grid square, that are located on a first line derived from the detected coordinate positions, and outputs coordinate positions of grid squares whose vote counts are greater than or equal to a vote threshold.

With this configuration, the predefined number of votes is added in a direction along the shape of the object. This increases the likelihood of an object being detected as present along its shape. Therefore, a decrease in object detection accuracy due to the shape of the object can be suppressed.

The reference numerals in parentheses associated with elements are provided merely as examples indicating correspondence between the elements and specific elements described in connection with the embodiments described below. Accordingly, the present disclosure is not limited by such reference numerals.

Hereinafter, embodiments will be described with reference to the accompanying drawings.

In the drawings, identical or equivalent elements in the embodiments described below and in other embodiments described later are denoted by the same reference numerals.

An object detection device according to the present embodiment suppresses a decrease in object detection accuracy and is applied to a host vehicle. The object detection device is configured to perform an object detection method and to execute an object detection program. The host vehicle to which the object detection device is applied will now be described.

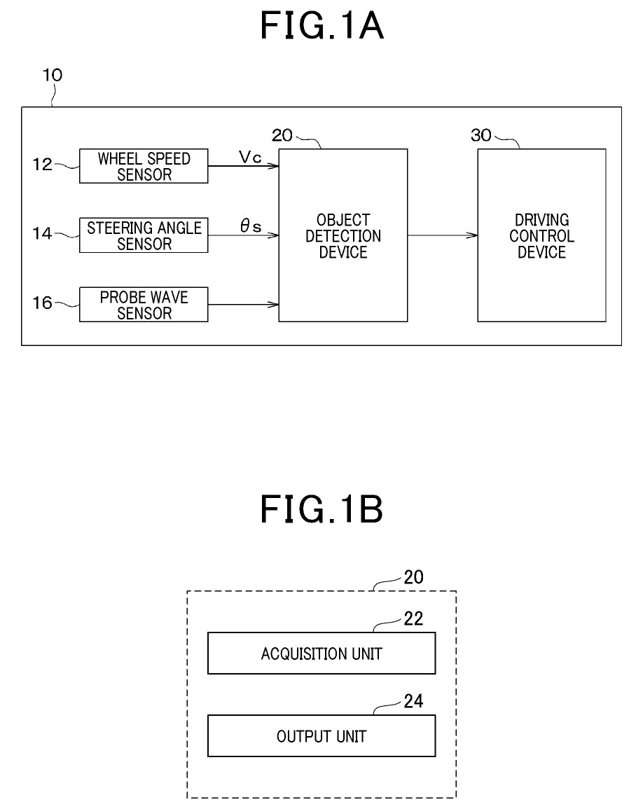

As illustrated in FIG. 1A, a host vehicle 10 includes a drive source such as an engine or a motor to travel on a road. The host vehicle 10 includes a wheel speed sensor 12, a steering angle sensor 14, a probe wave sensor 16, an object detection device 20, and a driving control device 30.

The wheel speed sensor 12 detects a rotational speed of wheels of the host vehicle 10. Accordingly, a vehicle speed Vc is detected by the wheel speed sensor 12. In addition, the wheel speed sensor 12 transmits a signal corresponding to the detected wheel speed Vc to the object detection device 20 described later. The vehicle speed Vc represents a travel speed of the host vehicle 10.

For example, the steering angle sensor 14 is attached to a steering rod of the host vehicle 10. The steering angle sensor 14 transmits a signal corresponding to the steering angle θs of the steering wheel, as operated by the driver of the host vehicle 10, to the object detection device 20 described later.

The probe wave sensor 16 transmits probe waves, such as millimeter waves, sonar waves, and infrared waves, to objects around the host vehicle 10. The probe wave sensor 16 receives reflected probe waves from these objects. The probe wave sensor 16 detects objects around the host vehicle 10 from the received reflected probe waves and calculates relative positions of respective detected objects with respect to the host vehicle 10. The probe wave sensor 16 transmits a signal corresponding to the calculated relative position of each detected object with respect to the host vehicle 10 to the object detection device 20 described later.

The object detection device 20 mainly includes a microcomputer and includes a CPU, a ROM, a flash memory, a RAM, an I/O interface, a communication interface, and a bus line that connects these components. The object detection device 20 executes a program stored in its ROM. The object detection device 20 acquires signals from the wheel speed sensor 12, the steering angle sensor 14, and the probe wave sensor 16. Based on the acquired signals, the object detection device 20 generates a grid map Mg by dividing an area around the host vehicle 10 into a plurality of grid squares. The object detection device 20 outputs a position of the host vehicle 10 on the generated grid map and positions of objects around the host vehicle 10 to a driving control device 30 described later. Details of processing performed by the object detection device 20 will be described later.

The driving control device 30 mainly includes a microcomputer and includes a CPU, a ROM, a flash memory, a RAM, an I/O interface, a communication interface, and a bus line that connects these components. The driving control device 30 executes a program stored in its ROM. With this configuration, the driving control device 30 acquires a position of the host vehicle 10 and positions of objects around the host vehicle 10 from the object detection device 20. Based on the acquired positions, the driving control device 30 reads out, from its flash memory, a stored route that is pre-stored in the flash memory and corresponds to the acquired positions. The stored route represents a route along which the host vehicle 10 has traveled.

The driving control device 30 controls a drive source, such as an engine or a motor, a power steering device, and a braking device of the host vehicle 10, which are not illustrated. The driving control device 30 performs autonomous driving so as to cause the host vehicle 10 to travel along the stored route that has been read. For example, the driving control device 30 performs automatic parking.

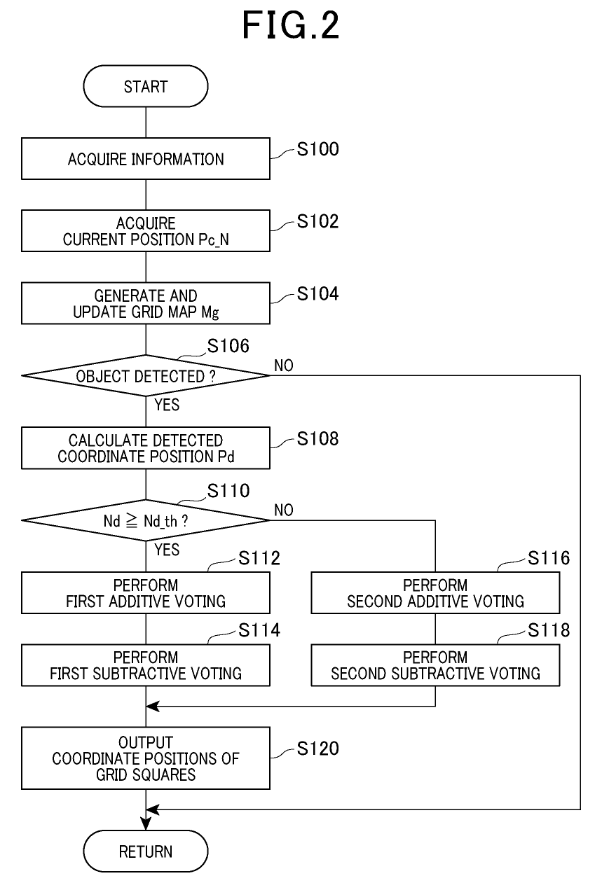

The host vehicle 10 to which the object detection device 20 is applied is configured as described above. Next, processing of the object detection device 20 is implemented by execution of a program for the object detection device 20 will be described with reference to the flowchart of FIG. 2. The program for the object detection device 20 is executed, for example, when a power source of the host vehicle 10 is turned on.

At step S100, the object detection device 20 acquires various items of information. Specifically, the object detection device 20 acquires a current vehicle speed Vc from the wheel speed sensor 12. The object detection device 20 also acquires a current steering angle θs from the steering angle sensor 14. Further, the object detection device 20 acquires, as detection results of the probe wave sensor 16, relative positions of objects with respect to the host vehicle 10.

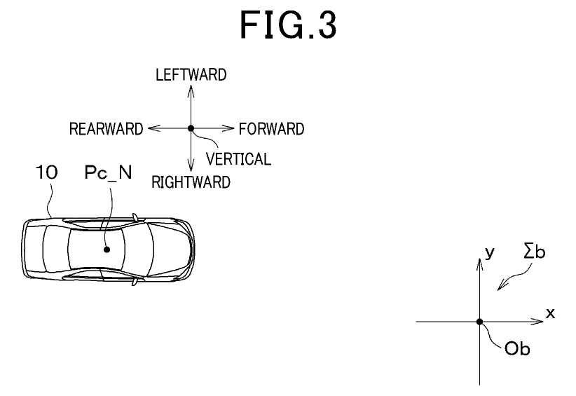

Here, as illustrated in FIG. 3, a coordinate system is defined as a reference coordinate system Σb, in which an axis extending in one direction perpendicular to the vertical direction of the host vehicle 10 is defined as an x-axis, and an axis extending in a direction perpendicular to the x-axis is defined as a y-axis. An origin Ob of the reference coordinate system Σb is arbitrarily set. At step S102 following step S100, the object detection device 20 calculates a current position Pc_N based on the vehicle speed Vc and the steering angle θs acquired at step S100 and a vehicle position Pc calculated in the previous cycle. The current position Pc_N corresponds to the current vehicle position Pc.

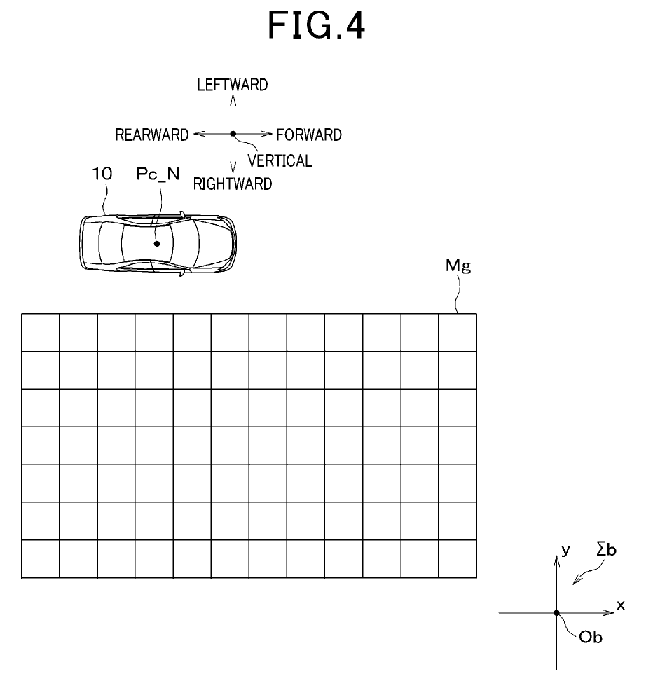

At step S104 following step S102 of the flowchart of FIG. 2, as illustrated in FIG. 4, the object detection device 20 generates a grid map Mg by dividing an area around the current position Pc_N calculated at step S102 into a plurality of grid squares. The object detection device 20 also adds the generated grid map Mg to the grid map Mg generated in the previous cycle. The object detection device 20 thus updates the grid map Mg. For example, each grid square of the grid map Mg has a square shape with a side length of several centimeters to several tens of centimeters.

At step S106 following step S104 of the flowchart of FIG. 2, the object detection device 20 determines, based on the relative positions of objects with respect to the host vehicle 10 acquired at step S100, whether the probe wave sensor 16 has detected an object around the host vehicle 10.

When the probe wave sensor 16 has not detected an object, the routine returns to step S100. When the probe wave sensor 16 has detected an object, the routine proceeds to step S108.

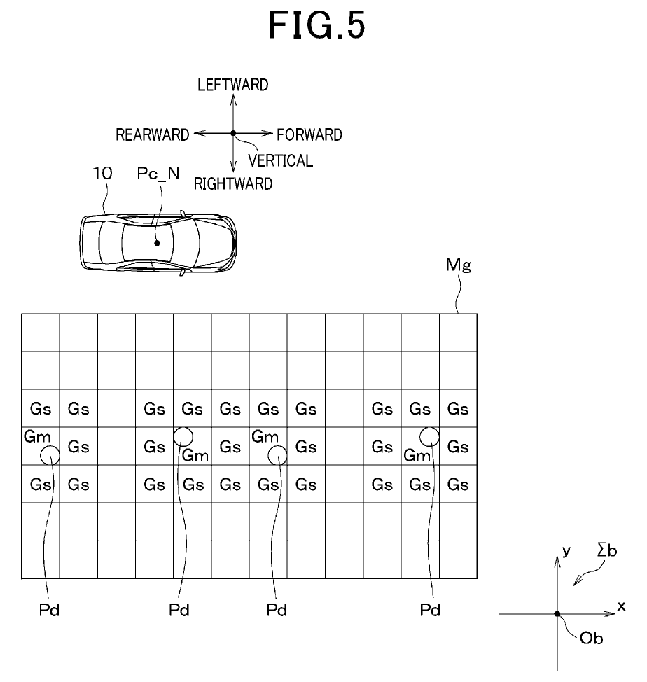

At step S108 following step S106, the object detection device 20 uses the relative positions of objects with respect to the host vehicle 10 acquired at step S100 and the current position Pc_N calculated at step S102. Then, the object detection device 20 calculates a detected coordinate position Pd for each object detected by the probe wave sensor 16. As illustrated in FIG. 5, each detected coordinate position Pd represents a coordinate position of an object detected by the probe wave sensor 16 in the reference coordinate system Σb, and corresponds to a coordinate position of the object on the grid map Mg.

Here, in order to describe processing following step S108, the following terms are defined. A grid square corresponding to the detected coordinate position Pd is defined as a main grid square Gm. Grid squares located around the main grid square Gm are defined as surrounding grid squares Gs.

Here, when an object detected by the probe wave sensor 16 has a complex shape, probe waves transmitted from the probe wave sensor 16 may undergo reflection inside the object, which may result in a smaller number of detected coordinate positions Pd.

Accordingly, at step S110 following step S108 in the flowchart of FIG. 2, the object detection device 20 determines whether the number of detected coordinate positions, Nd, is greater than or equal to a threshold Nd_th. The number of detected coordinate positions, Nd, represents the number of detected coordinate positions Pd. The threshold Nd_th for the number of detected coordinate positions, Nd, is set through experiments, simulations, or the like so as to determine whether the number of detected coordinate positions, Nd, is sufficiently large.

When the number of detected coordinate positions, Nd, is less than the threshold Nd_th, the number of detected coordinate positions, Nd, indicates a high likelihood that the object detected by the probe wave sensor 16 has a complex shape. In this case, the routine proceeds to step S116. When the number of detected coordinate positions, Nd, is greater than or equal to the threshold Nd_th, the number of detected coordinate positions, Nd, is sufficiently large. In this case, the routine proceeds to step S112.

At step S112 following step S110, when the number of detected coordinate positions, Nd, is sufficiently large, the object detection device 20 performs first additive voting.

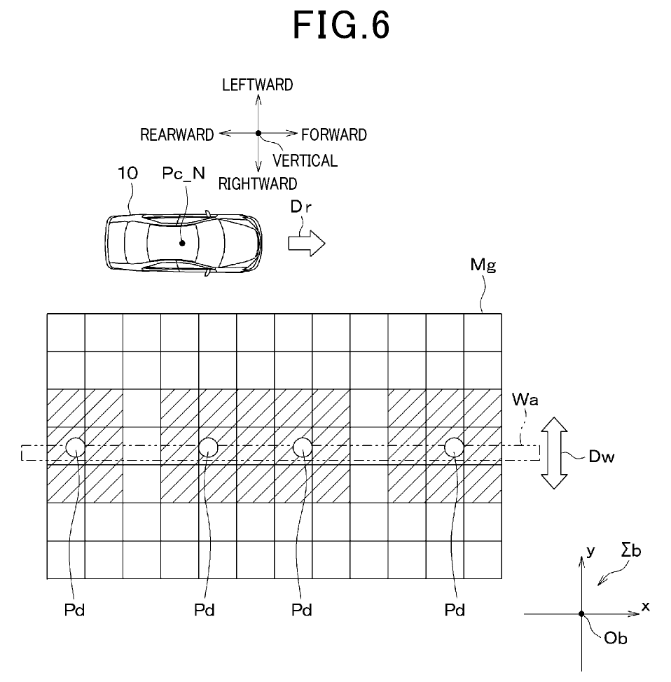

Here, as a comparative example, processing is performed using the object detection device disclosed in JP 2021-135192 A is assumed. Specifically, as illustrated in FIG. 6, a number of votes Nt is added to a vote count of a main grid square Gm and its surrounding grid squares Gs. The number of votes Nt represents an index indicating a probability of the presence of an object. As the number of votes Nt increases, the probability of the presence of the object increases. In FIG. 6, the main grid square Gm and its surrounding grid squares Gs whose vote counts have the number of votes Nt added are indicated by diagonal hatching.

In this case, when an object detected by the probing wave sensor 16 is a thin wall Wa extending in the travel direction Dr of the host vehicle 10, the number of votes Nt is added in a thickness direction Dw of the wall Wa, that is, in a direction perpendicular to the travel direction Dr and the vertical direction of the host vehicle 10. The number of votes Nt is also added to vote counts of grid squares at positions where the wall Wa does not actually exist. As a result, grid squares at positions where the wall Wa does not actually exist are identified as grid squares in which an object is present. Thus, in the object detection device described in JP 2021-135192 A, object detection accuracy may decrease depending on the shape of the object.

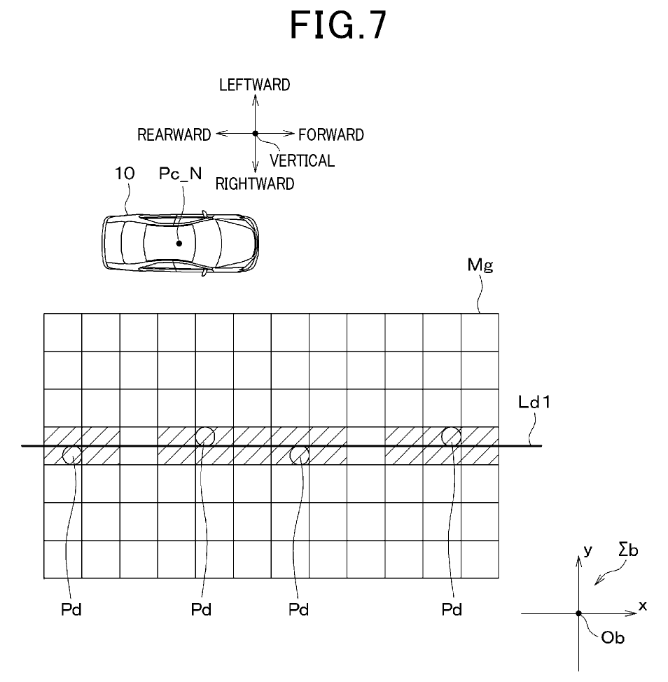

In contrast, as illustrated in FIG. 7, the object detection device 20 according to the present embodiment adds the number of votes Nt to the vote count of the main grid square Gm. The object detection device 20 calculates a first line Ld1 using the detected coordinate positions Pd calculated at step S108 and a least-squares method. The object detection device 20 adds the number of votes Nt to vote counts of surrounding grid squares Gs located on the first line Ld1 among the surrounding grid squares Gs. As a result, the number of votes Nt is added in a direction along the shape of the object. An object is more likely to be determined as being present along its shape. Therefore, a decrease in object detection accuracy due to the shape of the object can be suppressed. In FIG. 7, the main grid square Gm and its surrounding grid squares Gs whose vote counts have the number of votes Nt added are indicated by diagonal hatching.

At step S114 following step S112 in the flowchart of FIG. 2, the object detection device 20 performs first subtractive voting.

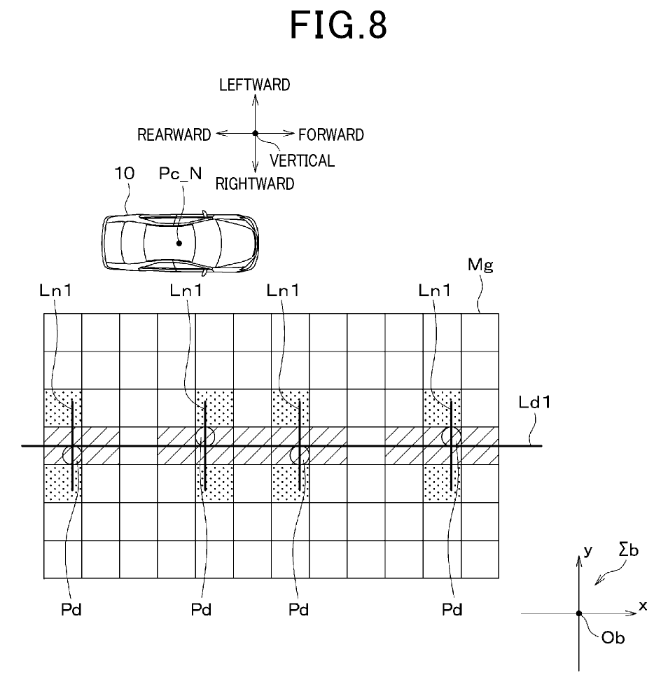

Specifically, the object detection device 20 calculates, for each detected coordinate position Pd, a first normal line Ln1 from the first line Ld1 calculated at step S112, as illustrated in FIG. 8. The first normal line Ln1 is a line that is perpendicular to the first line Ld1 and the vertical direction of the host vehicle 10, and that passes through the detected coordinate position Pd. Further, the object detection device 20 subtracts the number of votes Nt from the vote count of each of the surrounding grid squares Gs located on the first normal line Ln1 among the surrounding grid squares Gs. This configuration makes it less likely that grid squares at positions where no object actually exists are determined to be occupied by an object. Thus, a decrease in object detection accuracy can be suppressed. Thereafter, the routine proceeds to step S120. In FIG. 8, the surrounding grid squares Gs whose vote counts have the number of votes Nt subtracted are indicated by a dot pattern.

At step S116 following step S110, since the number of detected coordinate positions, Nd, is not sufficiently large, the object detected by the probe wave sensor 16 is highly likely to have a complex shape. In this case, the object detection device 20 performs second additive voting.

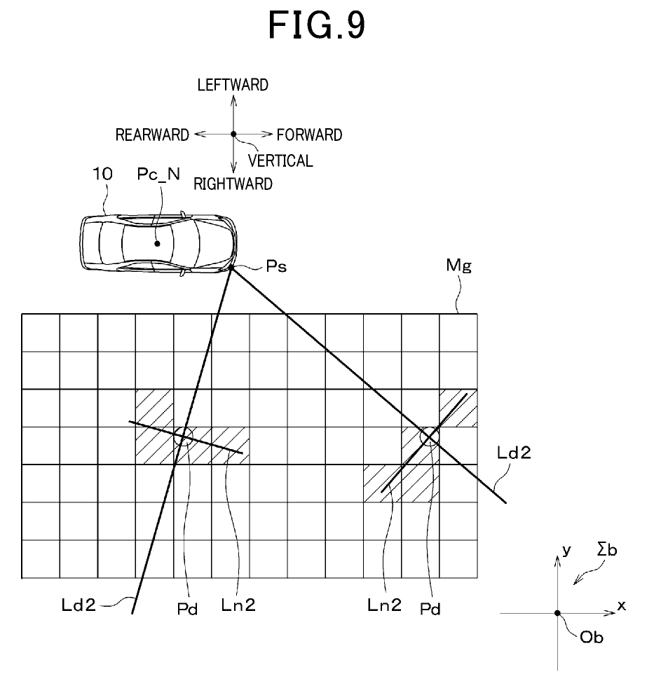

Specifically, as illustrated in FIG. 9, the object detection device 20 adds the number of votes Nt to the vote count of the main grid square Gm. The object detection device 20 calculates a sensor coordinate position Ps from the current position Pc_N calculated at step S102 and a predefined position of the probing wave sensor 16 mounted to the host vehicle 10. The sensor coordinate position Ps represents a coordinate position of the probing wave sensor 16 in the reference coordinate system Σb and corresponds to a coordinate position of the probing wave sensor 16 on the grid map Mg.

The object detection device 20 calculates, for each detected coordinate position Pd, a second line Ld2 from the sensor coordinate position Ps calculated as described above and the detected coordinate position Pd calculated at step S108. The second line Ld2 is a line connecting the sensor coordinate position Ps and the detected coordinate position Pd on the grid map Mg.

The object detection device 20 calculates, for each detected coordinate position Pd, a second normal line Ln2 from the second line Ld2 calculated as described above. The second normal line Ln2 is a line that is perpendicular to the second line Ld2 and the vertical direction of the host vehicle 10, and that passes through the detected coordinate position Pd.

The object detection device 20 adds the number of votes Nt to vote counts of surrounding grid squares Gs located on the second normal line Ln2 among the surrounding grid squares Gs. The probability of the presence of the object is thereby supplemented. This enables object detection on the grid map Mg even when the shape of the object detected by the probe wave sensor 16 is complex. In FIG. 9, the main grid square Gm and its surrounding grid squares Gs whose vote counts have the number of votes Nt added are indicated by diagonal hatching.

At step S118 following step S116 in the flowchart of FIG. 2, the object detection device 20 performs second subtractive voting.

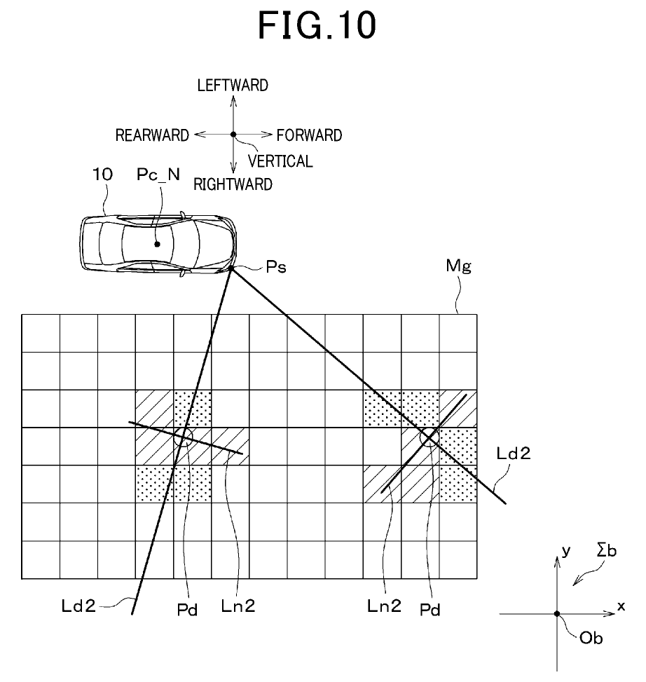

Specifically, as illustrated in FIG. 10, the object detection device 20 subtracts the number of votes Nt from the vote counts of surrounding grid squares Gs located on the second line Ld2 among the surrounding grid squares Gs. This configuration makes it less likely that grid squares at positions where no object actually exists are determined to be occupied by an object. Thus, a decrease in object detection accuracy can be suppressed. Thereafter, the routine proceeds to step S120. In FIG. 10, the surrounding grid squares Gs whose vote counts have the number of votes Nt subtracted are indicated by a dot pattern.

Returning to the flowchart of FIG. 2, at step S120, the object detection device 20 extracts coordinate positions of grid squares whose resultant vote counts, after additive voting and subtractive voting, are greater than or equal to a vote threshold Nt_th as coordinate positions of grid squares where an object is present. The object detection device 20 outputs the extracted coordinate positions of grid squares together with the current position Pc_N calculated at step S102 to the driving control device 30. The vote threshold Nt_th is set through experiments, simulations, or the like so that coordinate positions of grid squares in which an object is present are extracted based on the number of votes Nt.

As a result, the driving control device 30 reads, from its flash memory, a stored route corresponding to the current position Pc_N and the coordinate positions of grid squares acquired from the object detection device 20. The driving control device 30 controls a drive source, such as an engine or a motor, a power steering device, and a braking device of the host vehicle 10, which are not illustrated. The driving control device 30 performs autonomous driving so as to cause the host vehicle 10 to travel along the stored route that has been read. For example, the driving control device 30 performs automatic parking. Thereafter, the routine returns to step S100.

As described above, the object detection device 20 performs the routine. Next, how the object detection device 20 suppresses a decrease in object detection accuracy will be described.

As illustrated in FIG. 1B, the object detection device 20 functions as an acquisition unit 22 configured to acquire a grid map Mg and detected coordinate positions Pd at steps S100, S102, S104, and S108 in the flowchart of FIG. 2. At step S112, the object detection device 20 adds the number of votes Nt to vote counts of the main grid square Gm and surrounding grid squares Gs located on a first line Ld1 among all of the surrounding grid squares Gs of the main grid square Gm. At step S120, the object detection device 20 functions as an output unit 24 configured to output coordinate positions of grid squares whose vote counts are greater than or equal to a vote threshold Nt_th. The first line Ld1 corresponds to a line derived from the detected coordinate positions Pd.

As a result, the number of votes Nt is added in a direction along the shape of the object. This increases the likelihood of an object being detected as present along its shape. Therefore, a decrease in object detection accuracy due to the shape of the object can be suppressed.

The object detection device 20 of the present embodiment also achieves the effects described below.

[1] At step S114, the object detection device 20 subtracts the number of votes Nt from vote counts of surrounding grid squares Gs located on the first normal line Ln1 among all of the surrounding grid squares Gs.

This configuration makes it less likely that grid squares at positions where no object actually exists are determined to be occupied by an object. Thus, a decrease in object detection accuracy can be suppressed.

[2] The object detection device 20, at step S110 and step S116, performs additive voting by adding the number of votes Nt to vote counts of surrounding grid squares Gs on the second normal line Ln2 among all of the surrounding grid squares Gs when the number of detected coordinate positions, Nd, is less than a threshold Nd_th.

The probability of the presence of the object is thereby supplemented. This enables object detection on the grid map Mg even when the shape of the object detected by the probe wave sensor 16 is complex.

[3] At steps S110 and S118, when the number of detected coordinate positions, Nd, is less than the threshold Nd_th, the object detection device 20 subtracts the number of votes Nt from the vote counts of surrounding grid squares Gs located on the second straight line Ld2 among all of the surrounding grid squares Gs.

This configuration makes it less likely that grid squares at positions where no object actually exists are determined to be occupied by an object. Thus, a decrease in object detection accuracy can be suppressed.

### Other Embodiments

The present disclosure is not limited to the above-described embodiments, and various modifications can be made to the above-described embodiments as appropriate. Further, in each of the above-described embodiments, it goes without saying that elements constituting the embodiments are not necessarily essential, except for cases where such components are explicitly stated to be essential or are considered to be clearly essential in principle.

The acquisition unit and output unit and the method thereof described in the present disclosure may be realized by a dedicated computer provided by configuring a processor and memory programmed to perform one or more functions embodied in a computer program. Alternatively, the acquisition unit and output unit and the method thereof described in the present disclosure may be realized by a dedicated computer provided by configuring a processor with one or more dedicated hardware logic circuits. Alternatively, the acquisition unit and output unit and the method thereof described in the present disclosure may be realized by one or more dedicated computers configured by a combination of a processor and memory programmed to perform one or more functions, and a processor configured with one or more hardware logic circuits. In addition, the computer program may be stored in a computer-readable, non-transitory tangible storage medium as instructions to be executed by a computer.

In the above-described embodiment, the first line Ld1 is calculated using the detected coordinate positions Pd and a least-squares method. However, the calculation of the first line Ld1 is not limited to using the detected coordinate positions Pd and the least-squares method. For example, the first line Ld1 may be a line connecting detected coordinate positions Pd adjacent to each other.

The above-described embodiments may be combined with each other as appropriate.

What is claimed is:

1. An object detection device comprising:
an acquisition unit configured to acquire a grid map generated by dividing an area around a host vehicle into a plurality of grid squares, and detected coordinate positions that represent coordinate positions, on the grid map, of objects detected by a probe wave sensor; and
an output unit configured to add, for each of the detected coordinate positions, a predefined number of votes to a vote count of a main grid square corresponding to the detected coordinate position and to vote counts of surrounding grid squares that surround the main grid square and are located on a first line derived from the detected coordinate positions, and output coordinate positions of grid squares whose vote counts are greater than or equal to a vote threshold.

2. The object detection device according to claim 1, wherein
the output unit is configured to subtract, for each of the detected coordinate positions, the predefined number of votes from vote counts of surrounding grid squares that surround the main grid square and are located on a second line passing through the detected coordinate position, the second line being perpendicular to both the first line and a vertical direction of the host vehicle.

3. The object detection device according to claim 1, wherein
the output unit is configured to, in response to a number of the detected coordinate positions being greater than or equal to a threshold, add the predefined number of votes to the vote counts of the main grid square and surrounding grid squares that surround the main grid square and are located on the first line derived from the detected coordinate positions.

4. The object detection device according to claim 2, wherein
the output unit is configured to, in response to a number of the detected coordinate positions being greater than or equal to a threshold, perform, for each of the detected coordinate positions, first subtractive voting by subtracting the predefined number of votes from the vote counts of surrounding grid squares that surround the main grid square and are located on the second line.

5. The object detection device according to claim 4, wherein
the output unit is configured to, in response to the number of the detected coordinate positions being greater than or equal to a threshold, add the predefined number of votes to the vote counts of the main grid square and surrounding grid squares that surround the main grid square and are located on the first line derived from the detected coordinate positions.

6. The object detection device according to claim 3, wherein
the output unit is configured to, in response to the number of detected coordinate positions being less than the threshold, add, for each of the detected coordinate positions, the predefined number of votes to the vote counts of the main grid square and surrounding grid squares that surround the main grid square and are located on fourth line, the fourth line being perpendicular to both a third line connecting a sensor coordinate position of the probe wave sensor on the grid map and the detected coordinate position and a vertical direction of the host vehicle.

7. The object detection device according to claim 3, wherein
the output unit is configured to, in response to the number of detected coordinate positions being less than the threshold, perform, for each of the detected coordinate positions, second subtractive voting by subtracting the predefined number of votes from the vote counts of surrounding grid squares located on a third line connecting a sensor coordinate position of the probe wave sensor on the grid map and the detected coordinate position.

8. The object detection device according to claim 6, wherein
the output unit is configured to, in response to the number of detected coordinate positions being less than the threshold, perform, for each of the detected coordinate positions, second subtractive voting by subtracting the predefined number of votes from the vote counts of surrounding grid squares that surround the main grid square and are located on the third line.

9. An object detection method comprising:
acquiring a grid map generated by dividing an area around a host vehicle into a plurality of grid squares, and detected coordinate positions that represent coordinate positions, on the grid map, of objects detected by a probe wave sensor; and
adding, for each of the detected coordinate positions, a predefined number of votes to a vote count of a main grid square corresponding to the detected coordinate position and to vote counts of surrounding grid squares, surrounding the main grid square, that are located on a first line derived from the detected coordinate positions, and outputs coordinate positions of grid squares whose vote counts are greater than or equal to a vote threshold.

10. A computer program product comprising instructions which, when executed by a computer, cause the computer to perform an object detection method comprising:
acquiring a grid map generated by dividing an area around a host vehicle into a plurality of grid squares, and detected coordinate positions that represent coordinate positions, on the grid map, of objects detected by a probe wave sensor; and
adding, for each of the detected coordinate positions, a predefined number of votes to a vote count of a main grid square corresponding to the detected coordinate position and to vote counts of surrounding grid squares, surrounding the main grid square, that are located on a first line derived from the detected coordinate positions, and outputs coordinate positions of grid squares whose vote counts are greater than or equal to a vote threshold.
